(19) United States
(12) Patent Application Publication
(10) Pub. No.: US 2013/0290424 A1
(43) Pub. Date: Oct. 31, 2013

(54) METHOD AND SYSTEM OF PROVIDING OPTIMAL SERVICE USING PERSONAL INFORMATION OF USER

(71) Applicant: ELECTRONICS AND TELECOMMUNICATIONS RESEARCH INSTITUTE, (US)

(72) Inventors: Sang Hyun JOO, Daejeon (KR); Jin Seok KIM, Seoul (KR); Hyoung Joong KIM, Seoul (KR); Sung Wook BAIK, Seoul (KR); Naveed Ejaz, Seoul (KR)

(73) Assignee: ELECTRONICS AND TELECOMMUNICATIONS RESEARCH INSTITUTE, Daejeon (KR)

(21) Appl. No.: 13/870,619

(22) Filed: Apr. 25, 2013

Related U.S. Application Data
(60) Provisional application No. 61/638,087, filed on Apr. 25, 2012.

(30) Foreign Application Priority Data
Nov. 12, 2012 (KR) 10-2012-0127329

(51) Int. Cl. H04L 29/08

(52) U.S. Cl. CPC H04L 67/306
USPC 709/204

(57) ABSTRACT

Provided is a method of providing an optimal service to a user using personal information of the user, the method including: decentralizing and thereby setting personal information of the user that is included in a user description; extracting the personal information of the user from the user description; receiving a service request of the user and the extracted personal information of the user; selecting service information from a service description including the service information that is supported for the user, based on the personal information of the user in response to the service request of the user; and providing a service corresponding to the service information to the user.

### CROSS-REFERENCE TO RELATED APPLICATIONS

This application claims the priority benefit of U.S. Patent Provisional Application No. 61/638,087, filed on Apr. 25, 2012, in the U.S. Patent and Trademark Office, and Korean Patent Application No. 10-2012-0127329, filed on Nov. 12, 2012, in the Korean Intellectual Property Office, the disclosures of which are incorporated herein by reference.

### BACKGROUND

1. Field of the Invention

The present invention relates to a system and method for providing an optimal service to a user using personal information of the user, and more particularly, to technology of providing an optimal service to a user using personal information of the user that is included in a user description (UD).

2. Description of the Related Art

Technology of providing an optimal service to a user refers to technology of providing a service using only a portion of personal information of the user that is required in a predetermined service field. Since personal information of a user required in each service field differs, the personal information of the user may not be commonly used in the respective service fields.

### SUMMARY

Embodiments of the present invention provide a method, device, and system for providing an optimal service using personal information of a user that is included in a user description.

Also, embodiments of the present invention provide a method, device, and system for setting a user description by decentralizing and thereby storing and updating a personal information item and personal information of a user that are included in the user description.

Also, embodiments of the present invention provide a method, device, and system for applying a service description including service information during a process of providing an optimal service using personal information of a user that is included in a user description.

Also, embodiments of the present invention provide a method, device, and system for providing a service to a user when a separate service request of a user is absent.

According to an aspect of the present invention, there is provided a method of providing an optimal service to a user using personal information of the user, the method including: decentralizing and thereby setting personal information of the user that is included in a user description; extracting the personal information of the user from the user description; receiving a service request of the user and the extracted personal information of the user; selecting service information from a service description including the service information that is supported for the user, based on the personal information of the user in response to the service request of the user; and providing a service corresponding to the service information to the user.

The decentralizing and thereby setting may include decentralizing and thereby setting the personal information of the user for each item about the personal information of the user.

The optimal service providing method may further include setting an item about the personal information of the user that is included in the user description.

The decentralizing and thereby setting may include updating the personal information of the user through add, delete, and correct.

The user description may be stored in at least one of a portable device, a cloud environment, and a server.

The extracting may include extracting a portion of the decentralized and thereby set personal information of the user from the user description.

The extracting may include extracting an identifier corresponding to the personal information of the user, and the selecting may include: mapping the identifier to an identification table including the service information that is supported in the service description; and selecting the service information based on the identification table.

The mapping may include matching the identifier and at least one of a plurality of items of service information that are included in the identification table.

The identification table may include identifiers corresponding to personal information of a plurality of users, respectively, and a plurality of items of service information that are supported in the service description.

According to another aspect of the present invention, there is provided a method of providing an optimal service to a user using personal information of the user, the method including: decentralizing and thereby setting personal information of the user that is included in a user description; extracting the personal information of the user from the user description; receiving the extracted personal information of the user; selecting service information from a service description including the service information that is supported for the user, based on the personal information of the user; and providing a service corresponding to the service information to the user.

The decentralizing and thereby setting may include decentralizing and thereby setting the personal information of the user for each item about the personal information of the user.

The optimal service providing method may further include setting an item about the personal information of the user that is included in the user description. The item about the personal information of the user may further include a service request of the user about a predetermined service.

According to still another aspect of the present invention, there is provided a system for providing an optimal service to a user using personal information of the user, the system including: a user description; a service description; a user description extractor; and an application. The user description may include personal information of the user that is decentralized and thereby is set, and the service description may include service information that is supported for the user.

The user description may further include a personal information item of the user that is decentralized and thereby is set.

The user description extractor may extract the personal information of the user from the user description, and the application may receive a service request of the user and the extracted personal information of the user, may select the service information from the service description based on the personal information of the user in response to the service request of the user, and may provide a service corresponding to the service information to the user.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a service providing system including a user description (UD) and a service description (SD) according to an embodiment of the present invention;

FIG. 2 is a diagram illustrating a method of providing an optimal service to a user using personal information of the user according to an embodiment of the present invention;

FIG. 3 is a diagram illustrating a method of providing an optimal service to a first user using a UD of the first user and a UD of a second user according to an embodiment of the present invention;

FIG. 4 is a diagram illustrating a method of providing an optimal service to a user using personal information of the user when a separate service request of the user is absent according to an embodiment of the present invention; and

FIG. 5 is a flowchart illustrating a method of providing an optimal service to a user using personal information of the user according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

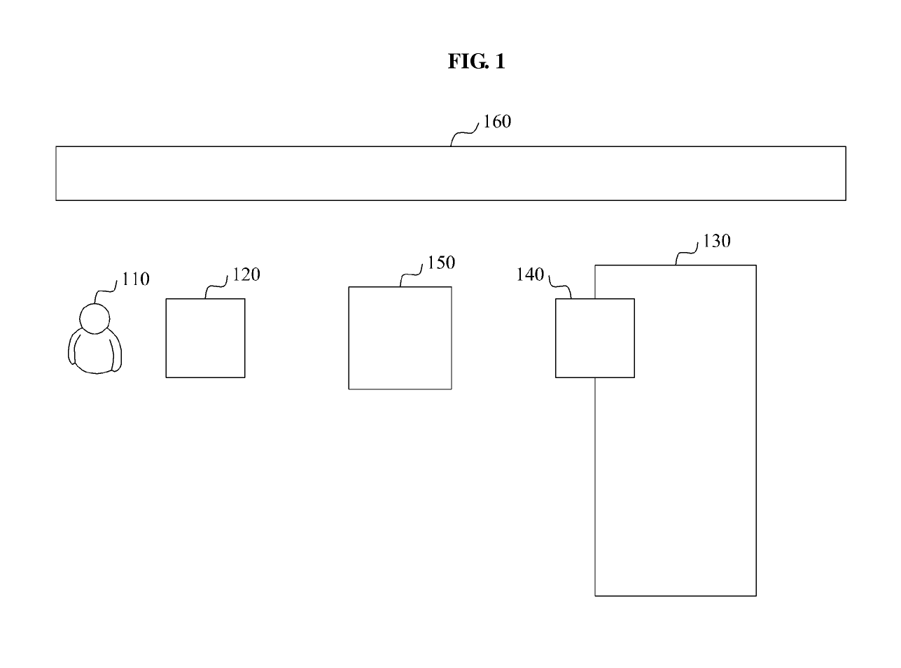

FIG. 1 is a diagram illustrating a service providing system including a user description (UD) 120 and a service description (SD) 140 according to an embodiment of the present invention.

Referring to FIG. 1, the service providing system may include a user 110, the UD 120 including personal information of the user 110, a plurality of services 130 that may be supported for the user 110, the SD 140 including service information supported for the user 110, a UD extractor 150 to extract personal information of the user 110 from the UD 120, and an application 160.

Here, the application 160 may receive a service request of the user 110 and the extracted personal information of the user 110, may select service information from the SD 140, based on personal information of the user 110 in response to the service request of the user 110, and may provide a service corresponding to the service information to the user 110. A description related thereto will be further described below.

Also, the UD 120 may be stored in at least one of a portable device, a cloud environment, and a service. For example, the UD 120 may be stored in a universal subscriber identity module (USIM) chip mounted to a smart device and thereby be used. A description related thereto will be further described below.

The SD 140 may store service information that may be supported for the user 110 in at least one of the portable device, the cloud environment, and the service. The service information that may be supported for the user 110 may be diversified over many fields. For example, the plurality of services 130 included in the SD 140 may include services in various fields such as repairing a mobile phone, navigation for driving a vehicle, and providing new, for example. Further, the plurality of services 130 that may be provided to the user 110 may include all of the services applicable by those skilled in the art.

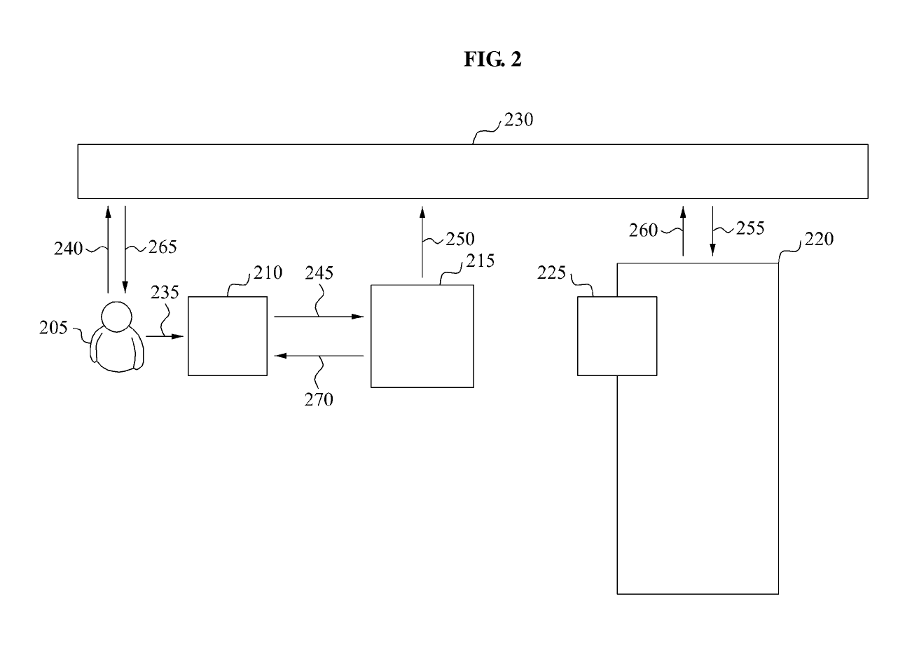

FIG. 2 is a diagram illustrating a method of providing an optimal service to a user using personal information of the user according to an embodiment of the present invention.

Referring to FIG. 2, a method of providing a service according to an embodiment of the present invention may be performed using a user 205, a UD 210 including personal information of the user 205, a plurality of services 220 that may be supported for the user 205, an SD 225 including service information supported for the user 205, a UD extractor 215 to extract personal information of the user 205 from the UD 120, and an application 230.

In the method of providing the service, the user 205 may decentralize and thereby update and set a personal information item and personal information included in the UD 210 of the user 205 through add, delete, and correct in operation 235. Here, the personal information item and the personal information of the user stored in the UD 210 may be expressed by the following Table 1.

TABLE 1

| User | Certificate | | |
|---|---|---|---|
| Identification | Private Key/ | | |
| | Public Key | | |
| | Cell phone Number | | |
| | E-mail Address | | |
| | Device MAC Number | | |
| Relationship | Family | Father/Mother/Brother/Sister | |
| | | Uncle/Aunt | |
| | | Cousin | |
| | Friends | Best | |
| | | Middle School/High School/ | |
| | | University | |
| | | Company | |
| Intention | Emotion | | |
| | Plan | | |
| Capability | Device | Cell phone | MAC Number/IP |
| | Capability | | Address |
| | | Mobile Note | MAC Number/IP |
| | | | Address |
| | | Laptop | MAC Number/IP |
| | | | Address |
| | | Desktop | MAC Number/IP |
| | | | Address |
| | | TV | MAC Number/IP |
| | | | Address |
| | | Audio | MAC Number/IP |
| | | | Address |
| | Finance | Credit Rating/Annual Income | |
| | Capability | Bank Name/Account Number | |
| | | Account Balance | |
| | Academic | Middle/High | Graduation year |
| | Capability | School | |
| | | University | Graduation year |
| | | Company | Resignation year |

| | | |
|---|---|---|
| History | Region | House Address |
| | | Trip History |
| | Multimedia | Type |
| | Consumption | |
| | Criminal Record | Date/punishment |
| | Medical Record | Date/Disease/treatment |
| Interest | Religion | |
| | Philosophy | |
| | Art & | |
| | Entertainment | |
| | Sports | |

Here, personal information may be set to correspond to a personal information item. For example, a private key such as “20120711” and the like may be input and thereby be set in the personal information item “private key/public key”. Also, personal information items “region”, “medical record”, “religion”, and the like, may be adaptively set based on a service environment. The personal information items may include “identification” “location”, “favorite”, “history”, “finance”, “medical”, “academy”, “education”, “criminal record”, “vehicle”, “tour”, “sports”, “culture”, “emotion”, and the like of the user 205. For example, when the UD 210 is set for a service using public transportation, a bus route and a subway route generally used may be added. For example, in the method of providing the optimal service to the user 205, a personal information item and personal information included in the UD 210 may include a personal information item and personal information applicable by those skilled in the art.

Here, personal information to be stored in the UD 210 may be decentralized and thereby be stored.

When a personal information item and personal information to be included in the UD 210 are set, the UD extractor 215 may extract personal information of the user 205 from the UD 210 in operation 245. A process of extracting personal information of the user 205 may be a process of extracting an identifier corresponding to the personal information of the user 205. Here, the extracted personal information of the user 205 is personal information of the user 205 that is decentralized and thereby be set, and may be a limited portion of personal information of the user 205. Accordingly, personal information of the user 205 that is used by the application 230 may also be a limited portion of the decentralized and thereby set personal information of the user 205.

Also, the application 230 may receive the extracted personal information of the user 205 in operation 250, and may receive a service request of the user 205 in operation 240. Here, the application 230 may be installed in a terminal of the user 205 or may be stored in a server and thereby operate.

The application 230 may access the SD 225 including service information supported for the user 205 in operation 255, may select a predetermined optimal service from among a plurality of items of service information included in the SD 225, based on the service request of the user 205 and the extracted personal information of the user 205 in operation 260, and may provide the optimal service to the user 205 in operation 265. Here, a process of selecting the predetermined optimal service from among the plurality of items of service information 220 based on the request of the user 205 and the extracted personal information of the user 205 may be a process of mapping the extracted identifier to an identification table including the service information that is supported in the SD 225 and selecting service information based on the identification table. Also, mapping the identifier to the identification table may indicate mapping the identifier and at least one of the plurality of service information that are included in the identification table. Here, the identification table may include identifiers corresponding to personal information of a plurality of users, respectively, and the plurality of items of service information that are supported in the SD 225.

The UD 210 including the extracted personal information of the user 205 may be updated again in operation 270. An example thereof will be further described below.

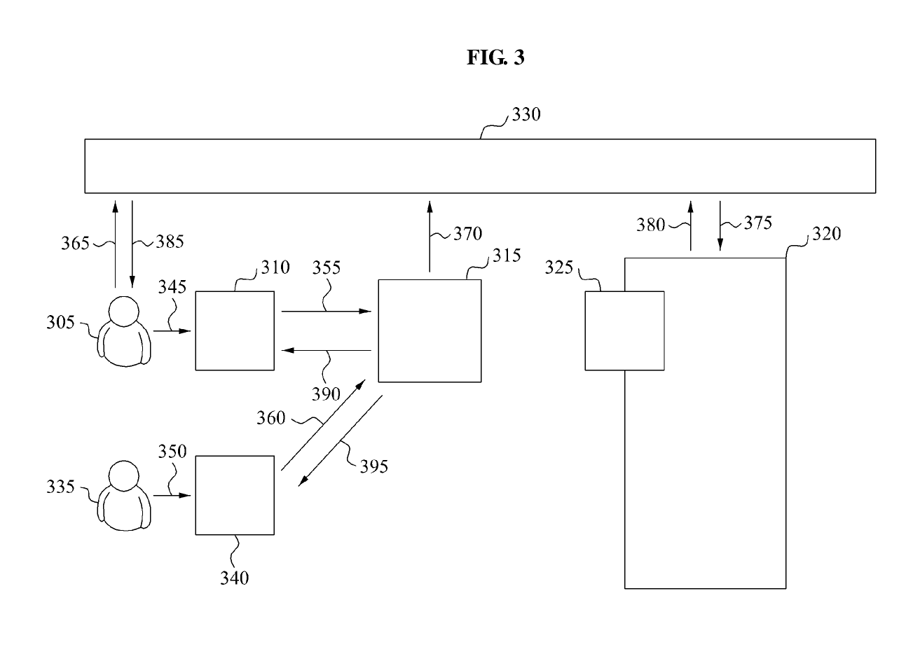

FIG. 3 is a diagram illustrating a method of providing an optimal service to a first user using a UD of the first user and a UD of a second user according to an embodiment of the present invention.

Referring to FIG. 3, a method of providing a service according to an embodiment of the present invention may be performed using a first user 305, a second user 335, a first UD 310 including personal information of the first user 305, a second UD 340 including personal information of the second user 335, a plurality of services 320 that may be supported for the first user 305 and the second user 335, an SD 325 including service information supported for the first user 305 and the second user 335, a UD extractor 315 to extract personal information of the first user 305 and the second user 335 from the first UD 310 and the second UD 340, respectively, and an application 330.

For example, in a method of providing a navigation service to the first user 305 desiring to a vehicle owned by the second user 335, the first user 305 may set personal information of the first user 305 in the first UD 310 in operation 345. In operation 350, the second user 335 may set personal information of the second user 335 in the second UD 340.

In operations 355 and 360, the UD extractor 315 may extract personal information of the first user 305 and personal information of the second user 335 that are stored in the first UD 310 and the second UD 340, respectively. Here, the extracted personal information of the first user 305 and personal information of the second user 335 may be personal information that is decentralized and thereby is stored in the first UD 310 and the second UD 340, respectively, and may be a limited portion thereof.

The application 330 may receive the extracted personal information of the first user 305 and personal information of the second user 335 in operation 370, may receive a driving request of the first user 305 in operation 365, may access the SD 325 in response to the driving request of the first user 305 in operation 375, and may select a navigation service from among the plurality of services 320 included in the SD 325 in operation 380.

By updating vehicle information owned by the second user 335 to the first UD 310 of the first user 305 in operation 390, vehicle information of the second user 335 may be included in the first UD 310. Also, by updating the second UD 340 of the second user 335 in operation 395, it is possible to recognize that the vehicle owned by the second user 335 is being driven by the first user 305.

In operation 385, the selected navigation service may be provided based on personal information pre-set by the first user 305 and the updated vehicle information of the second user 335. More specifically, for example, when the first user 305 registers a home address of the first user 305 to personal information of the first user 305 and an amount of oil currently filled in the vehicle of the second user 335 is registered to personal information of the second user 335, the navigation service may recognize that the amount of oil currently filled in the vehicle of the second user 335 is insufficient to get to a home of the first user 305 from a current location and may guide the first user 305 to drive home via a gasoline station nearby based on current position information of the first user 305 during a process of updating vehicle information of the second user 335 to the first UD 310 of the first user 305.

That is, a method of providing the optimal service to the first user 305 using the first UD 310 of the first user 305 and the second UD 340 of the second user 335 may provide the optimal service to the first user 305 or the second user 335 based on personal information of the first user 305 stored in the first UD 310 and personal information of the second user 335 stored in the second UD 340 in operation 385.

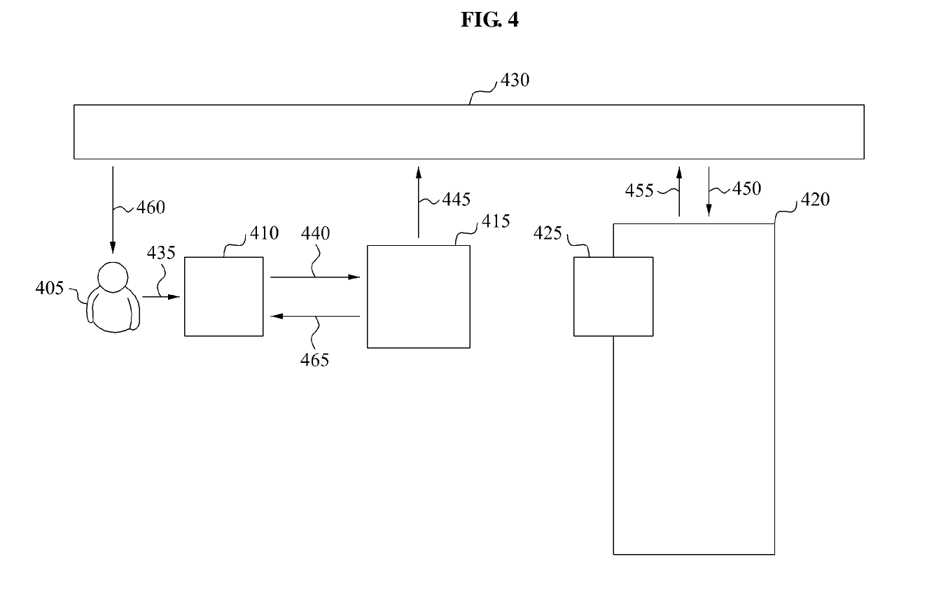

FIG. 4 is a diagram illustrating a method of providing an optimal service to a user using personal information of the user when a separate service request of the user is absent according to an embodiment of the present invention.

Referring to FIG. 4, a method of providing a service according to an embodiment of the present invention may be performed using a user 405, a UD 410 including personal information of the user 405, a plurality of services 420 that may be supported for the user 405, an SD 425 including service information supported for the user 405, a UD extractor 415 to extract personal information of the user 405 from the UD 410, and an application 430.

For example, in a method of providing a news service to the user 405, personal information to be included in the UD 410 of the user 405 may be set in operation 435. Here, a personal information item to be included in the UD 410 may include information used to automatically request a news service at a predetermined time every day. Accordingly, the user 405 may receive a daily news service without separately requesting the news service.

In operation 440, the UD extractor 415 may extract personal information stored in the UD 410. The application 430 may receive the extracted personal information of the user 405 in operation 445 and may access the SD 425 based on the received personal information in operation 450. The application 430 may select a service for providing news at predetermined time everyday from among the plurality of services 420 included in the accessed SD 425 in operation 455. The selected service may be provided to the user 405 in operation 460.

By updating a result of having provided the news service at a corresponding date to the UD 410 of the user 405 in operation 465, it may be possible to prevent the news service from being repeatedly provided.

According to an embodiment of the present invention, a method of providing an optimal service to a user may include a service request in a personal information item of a UD without a separate user request and thereby apply the service request.

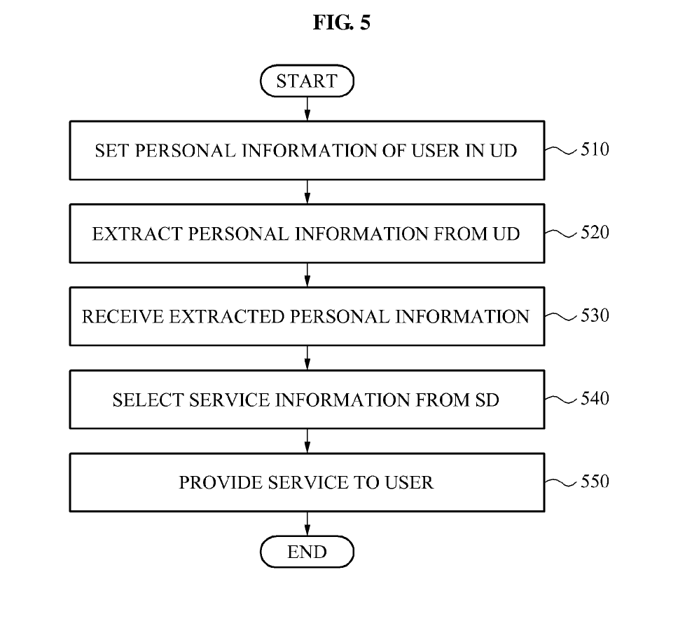

FIG. 5 is a flowchart illustrating a method of providing an optimal service to a user using personal information of the user according to an embodiment of the present invention.

Referring to FIG. 5, in operation 510, personal information of a user to be included in a UD may be set.

In operation 520, the set personal information of the user may be extracted from the UD using a UD extractor. Operation 520 of extracting personal information of the user may be an operation of extracting an identifier corresponding to the personal information of the user. The extracted personal information of the user may be personal information of the user that is decentralized and thereby set and thus, may be a limited portion of the personal information of the user.

In operation 530, an application may receive the extracted personal information and a service request of the user.

In operation 540, the application may select predetermined service information optimized to be provided to the user from among a plurality of items of service information that are included in an SD including service information supported for the user, based on personal information of the user and the service request. The extracted identifier may be mapped to an identification table including service information that is supported in an SD, and service information may be selected based on the mapped identification table.

In operation 550, the selected predetermined service information may be provided to the user. Also, service details additionally provided to the user may be updated again to the UD of the user.

The units described herein may be implemented using hardware components and software components. For example, the hardware components may include microphones, amplifiers, band-pass filters, audio to digital converters, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) to and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing to higher level code that may be executed by the computer using an interpreter. The described hardware devices may be configured to act as one or more software modules in order to perform the operations of the above-described exemplary embodiments of the present invention, or vice versa.

According to embodiments of the present invention, there may be provided a method, device, and system for providing an optimal service using personal information of a user that is included in a user description.

Also, according to embodiments of the present invention, there may be provided a method, device, and system for setting a user description by decentralizing and thereby storing, and updating a personal information item and personal information of a user that are included in the user description.

Also, according to embodiments of the present invention, there may be provided a method, device, and system for applying a service description including service information during a process of providing an optimal service using personal information of a user that is included in a user description.

Also, according to embodiments of the present invention, there may be provided a method, device, and system for providing a service to a user when a separate service request of a user is absent.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of providing an optimal service to a user using personal information of the user, the method comprising:
decentralizing and thereby setting personal information of the user that is included in a user description;
extracting the personal information of the user from the user description;
receiving a service request of the user and the extracted personal information of the user;
selecting service information from a service description including the service information that is supported for the user, based on the personal information of the user in response to the service request of the user; and
providing a service corresponding to the service information to the user.

2. The method of claim 1, wherein the decentralizing and thereby setting comprises decentralizing and thereby setting the personal information of the user for each item about the personal information of the user.

3. The method of claim 2, further comprising:
setting an item about the personal information of the user that is included in the user description.

4. The method of claim 1, wherein the decentralizing and thereby setting comprises updating the personal information of the user through add, delete, and correct.

5. The method of claim 1, wherein the user description is stored in at least one of a portable device, a cloud environment, and a server.

6. The method of claim 1, wherein the extracting comprises extracting a portion of the decentralized and thereby set personal information of the user from the user description.

7. The method of claim 1, wherein:
the extracting comprises extracting an identifier corresponding to the personal information of the user, and
the selecting comprises:
mapping the identifier to an identification table including the service information that is supported in the service description; and
selecting the service information based on the identification table.

8. The method of claim 7, wherein the mapping comprises matching the identifier and at least one of a plurality of items of service information that are included in the identification table.

9. The method of claim 7, wherein the identification table comprises identifiers corresponding to personal information of a plurality of users, respectively, and a plurality of items of service information that are supported in the service description.

10. A method of providing an optimal service to a user using personal information of the user, the method comprising:
decentralizing and thereby setting personal information of the user that is included in a user description;
extracting the personal information of the user from the user description;
receiving the extracted personal information of the user;
selecting service information from a service description including the service information that is supported for the user, based on the personal information of the user; and
providing a service corresponding to the service information to the user.

11. The method of claim 10, wherein the decentralizing and thereby setting comprises decentralizing and thereby setting the personal information of the user for each item about the personal information of the user.

12. The method of claim 11, further comprising:
setting an item about the personal information of the user that is included in the user description,
wherein the item about the personal information of the user further comprises a service request of the user about a predetermined service.

13. A system for providing an optimal service to a user using personal information of the user, the system comprising:
a user description;
a service description;
a user description extractor; and
an application,
wherein the user description comprises personal information of the user that is decentralized and thereby is set, and
the service description comprises service information that is supported for the user.

14. The system of claim 13, wherein the user description further comprises a personal information item of the user that is decentralized and thereby is set.

15. The system of claim 13, wherein:
the user description extractor extracts the personal information of the user from the user description, and
the application receives a service request of the user and the extracted personal information of the user, selects the service information from the service description based on the personal information of the user in response to the service request of the user, and provides a service corresponding to the service information to the user.
